(19) United States
(12) Patent Application Publication
(10) Pub. No.: US 2008/0255688 A1
(43) Pub. Date: Oct. 16, 2008

(54) Changing a display based on transients in audio data

(76) Inventors: Nathalie Castel, Los Angeles, CA (US); Gregory Evan Niles, Culver City, CA (US)

Correspondence Address: HICKMAN PALERMO TRUONG & BECKER LLP/Apple Inc., 2055 GATEWAY PLACE, SUITE 550, SAN JOSE, CA, 95110-1083, US

(21) Appl. No.: 11/786,958

(22) Filed: Apr. 13, 2007

(51) Int. Cl. G06F 17/00

(52) U.S. Cl. 700/94

(57) ABSTRACT

A method and apparatus for changing a visual display in response to transients in audio data is provided. Transients, or sudden changes in frequency, in audio data is correlated to abrupt sounds in the audio data such as beats that cannot be easily detected by analyzing the audio data's amplitude or frequency alone. Detecting transients provides a user with a way to change a visual display based on the abrupt changes in audio data. The user can also specify various frequency ranges of interest within which transient detection is performed and correlate these detections with different changes in the visual display.

### FIELD OF THE INVENTION

The present invention relates to the field of animation, and more specifically to generating visual images based on audio data.

### BACKGROUND

Much effort has been spent on developing tools for animation to correlate animated visual images to some audio data, often a piece of music. The “visualizer” function on iTunes™, where random imagery is generated in response to a song being played, is one such example. Although this kind of “visualizer” generates visual images that are in part based on the song being played, much of the visual images are also randomly generated. As a result, when the same song is played twice, the visual images generated by the “visualizer” are different the first and second times the song is played.

Others have made efforts to develop tools to correlate visual images to audio data in a predictable and controllable manner. One approach allows a user to correlate a property of a visual image to the amplitude of the audio data. For example, a user can specify that the size of a square on display be enlarged whenever the amplitude, or loudness, of a piece of music reaches a certain level. Conversely, a user can specify that the square be decreased in size whenever the music's loudness drops below a certain level.

Another approach allows a user to control the output of visual images based on the frequencies in audio data. For example, a user can specify that a square on display be increased if certain frequencies are detected.

However, some properties of audio data are not easily detected by analyses of amplitudes or frequencies. For example, a beat may not significantly alter the loudness of a piece of music. At the same time, it may also be difficult for a user to specify the precise frequencies of a particular beat in order to detect the existence of such frequencies. As a result, tools that only provide analyses of amplitude or frequencies alone cannot provide a way for users to generate visual images based on abrupt sounds, like beats, in audio data.

In view of the foregoing, there is a need for an approach to provide generation of visual images based on abrupt sounds in audio data.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart illustrating an example procedure for changing a visual display in response to detecting transients in audio data.

FIG. 2 is a depiction of an example of how a parameter of an image element changes over time in response to detections of transients.

FIG. 3 is a block diagram of a computer system upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### Overview

An approach for generating visual displays, based on the detection of transients in the audio data, is disclosed herein. A transient occurs when there is a sudden change in frequency in the audio data. This sudden change in frequency can be a sudden increase or a sudden decrease in frequency. Such changes can occur throughout the entire length of the audio data and can occur over the entire range of frequencies contained in the audio data. When a transient is detected in audio data, a value used in generating a visual display synchronized to the audio data can be modified in response to this detection. After transient detection analysis has been completely performed on the audio data, a series of visual displays synchronized to the audio data may be generated such that a visual display synchronized to a particular point in time in the audio data may be visually different depending on whether a transient was detected at that point in time in the audio data.

According to an embodiment, detection of a transient at a point in time in audio data occurs independently of the amplitude of the audio data at that same point in time. That is, whether or not there is a transient at a point in time is not correlated to the amplitude at that time. Similarly, the detection of a transient is also different from the detection of a specific frequency—the mere existence of a specific frequency at a point in time is not correlated to whether there are sudden changes in frequencies at that point in the audio playback. As a result, transient detection provides a user with a type of analysis of audio data that is different from analyses of amplitudes and frequencies alone; although, in certain embodiments, analyses of amplitudes and frequencies alone may also be used with the techniques discussed herein, in addition to other types of analyses.

In an embodiment, since transients are sudden changes in frequencies, they are usually correlated with sounds such as a drum beat or cymbal clashing. These types of sounds are not easily correlated to analyses of amplitude or frequencies alone. As a result, approaches discussed herein for generating visual displays based on transients in the playback of audio data provide a way for users to use abrupt sounds like beats to trigger the generation of visual images.

Furthermore, while changes in amplitude and frequency occur relatively slowly and smoothly over time, transients may occur over short periods of time. As a result, generating visual displays on transients results in short, snappy visual changes that are not possible if the generation of visual displays are based only on amplitudes and frequencies.

An embodiment allows a user to link the detection of transients to certain parameters of a visually displayed image element. For example, an image element may be a simple square, and a parameter may be the size, color, or tilt of the square. A user may, in an embodiment, link the detection of the transient to the color of the square, such that the color changes from white to green at all points in time where a transient is detected.

In another embodiment, a user can specify a range of frequencies within which to detect transients. This gives the user further control over the correlation of abrupt sounds in audio data to the display of visual images.

Similarly, in an embodiment, a user can specify multiple ranges of frequencies, such that the detection of a transient in one range results in one change to the visual display (e.g., a square turning from white to green) and the detection of a transient in another range results in a different change to the visual display (e.g., a square rotating forty-five degrees). This approach provides the user with a way to specify a diverse set of visual responses for different abrupt sounds in audio data.

Finally, in an embodiment, a user can separate the entire audio data into different periods and specify that the generation of visual displays in response to transients in one period be different from the generation of visual displays in another period.

### Changing a Display Based on Transients in Audio Data

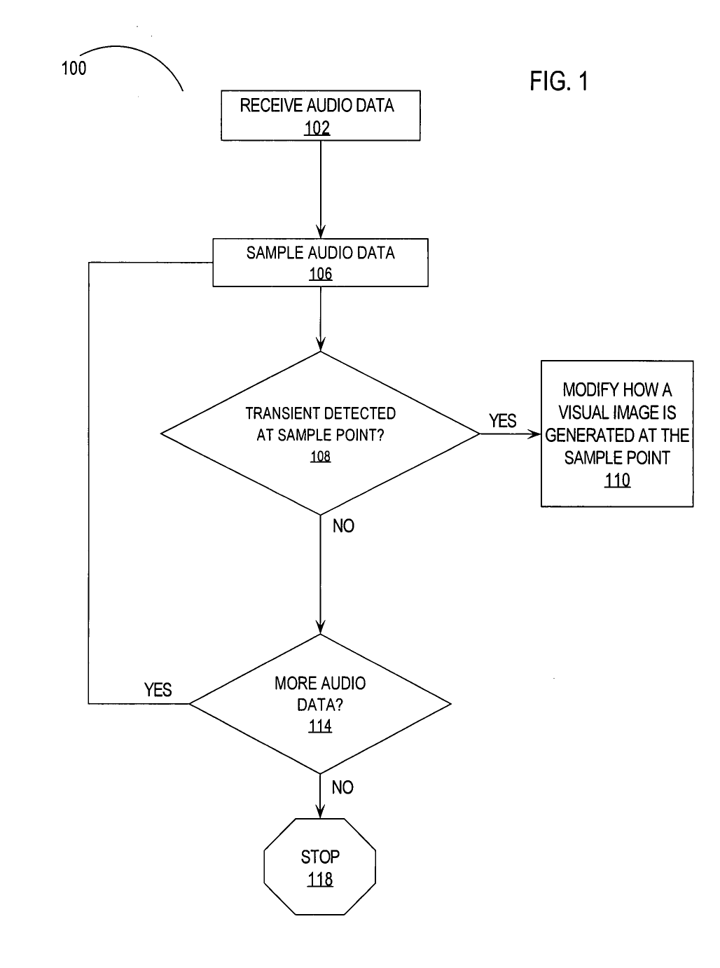

FIG. 1 is a flowchart illustrating steps of a process 100 of an embodiment of the current invention where a visual display is changed in response to detection of transients during playback of audio data.

In step 102, audio data is received. This audio data is usually, though not limited to, a piece of music. The audio data may be received from a variety of sources, such as: memory or hard disk in a computer system, CDs, DVDs, or external hard drives. The audio data may be selected automatically by an application using this embodiment. Alternatively, the audio data may also be selected by a user. In an example application, a user can select the audio data from several choices in a pull-down menu or by browsing the file system of a computer system.

In step 106, analysis of the audio data commences, and the audio data is sampled at a sampling rate. Each time the audio data is sampled, the point in time where this sampling occurs is a sample point. The sampling rate is the number of sample points in a set amount of time. An application using this embodiment may provide a default sampling rate, such as the frame rate of the video data. In addition, a user can select a sampling rate through the user interface of the application. For example, the user can type in the desired sampling rate or select from a plurality of sample rates in a pull-down menu in the application.

In step 108, the audio data is analyzed at a sample point to detect any transients. That is, the audio data is analyzed to determine whether there is a sudden increase or decrease in frequency in the audio data at the sample point. Various methods and algorithms for transient detection exist in the art.

If a transient was detected, step 110 is performed. In step 110, a value that is used in generating a visual display associated with the sample point is modified. In one embodiment, an application generates a series of visual displays synchronized with audio data at a sampling rate such that by default, a visual display of a square is generated at each sample point. If a transient is detected at a sample point, however, a value in the application may be modified to indicate that a circle should be displayed instead of a square at that sample point.

If no transient was detected, the default generation of visual displays is not modified.

In another embodiment, the default generation of visual displays may be the display of the frames from a first source of video data, and the sampling rate may be the frame rate of the first source of video data. At a sample point, if a transient is detected, step 110 is performed, and a value may be modified to indicate that when generating the visual display for that sample point, a substitute frame should be displayed. This substitute frame need not be the same frame for every sample point. There may be second source of video data such that at every sample point, the corresponding frame from the second video data is substituted if a transient is detected.

In another embodiment, the generation of visual displays may generate a sequence of animated frames. As above, the sampling rate may be the frame rate of the sequence of animated frames. The sequence of animated frames can display, for example, a circle continuously getting larger and then smaller. At a sample point, if a transient is detected, step 110 is performed and a value may be modified to indicate that at that sample point, a circle of a different color should be generated and displayed. Similarly, the new frames generated in response to a transient being detected may differ every time a transient is detected. For example, a user may specify in the application that what kind of new frame is generated depends on how many times a transient have been detected. In this example, the circle generated may be green on the first detection, blue on the second detection, red on the third detection, etc.

The process of sampling the audio data, detecting a transient, and modifying the generation of a visual image based on transient detection is repeated until the end of the audio data is reached. If all audio data has been sampled, step 118 is reached and no more processing is done.

At the end of this process, a series of visual displays may be generated based on values that may have been modified in response to transient detection in the audio data. In the first embodiment described above, the generation of visual displays generates an image of a square by default and generates a circle if a transient is detected. In this embodiment, if the audio data is played back such that it is synchronized with the generation of visual images, a square is normally displayed throughout the playback of the audio data, but a circle is displayed whenever there is a transient, such as a drumbeat, in the audio data.

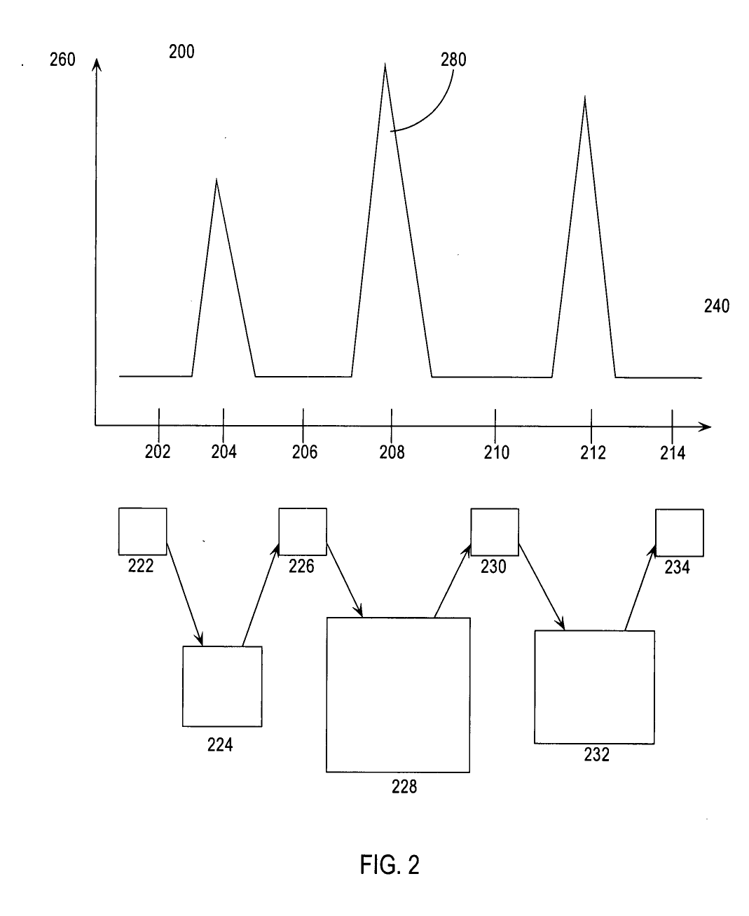

FIG. 2 illustrates an example embodiment of how transient detection results in a changed visual image. Graph 200 depicts a horizontal axis 240 representing time, and a vertical axis 260 representing transients. Waveform 280 is a depiction of the change in frequency over time for an audio data. Sample points 202, 204, 206, 208, 210, 212, and 214 are points in time at which the audio data is sampled and detection of transients is performed.

In the example in FIG. 2, a series of image elements are generated for the visual displays at each sample point. For a sample point, the default image element is a small square. In this example, when a transient is detected at a sample point, the value that indicates the size of the square generated is modified such that the generated square becomes larger when transients are detected, relative to the size of the transients. Squares 222, 224, 226, 228, 230, 232, and 234 are image elements that are generated following the transient analysis of the audio data.

At sample point 202 there are no transients. As a result, default square 222 is generated.

At sample point 204, however, there is a sudden change in frequency and a transient is detected. As a result, the larger square 224 is generated. In other words, the generated visual display showed square 222 at sample point 202, which changed to square 224 at sample point 204.

At sample point 206, again there are no transients and square 226 is displayed, replacing square 224. Square 226 is the same size as square 222.

At sample point 208, a transient is detected and this transient is larger than the transient detected at sample point 204. As a result, the large square 228 is generated. Square 228 is bigger than square 224. In other embodiments, the square may become smaller, or one or more properties of the image element may change in response to the detection and characteristics of the transient.

At sample point 210, again there are no transients and square 230 is generated, replacing square 228. Square 230 is the same size as squares 222 and 226.

At sample point 212, a transient is detected and as a result, square 232 is displayed, replacing square 230. Because the transient at sample point 212 is larger than the one at sample point 204 but smaller than the transient at sample point 208, square 232 is larger than square 223 but smaller than square 228.

Finally, at sample point 214, again no transients are detected and square 234 is generated, which is the same size as squares 222, 226, and 230.

It is significant that while in one embodiment, transient analysis is performed prior to playback of the audio data, alternate embodiments exist wherein the transient detection occurs on real-time or at any time.

### Specifying Ranges

In the embodiments outlined in FIG. 1 and illustrated in FIG. 2, detection of transients is performed over the entire frequency range of the audio data. Sometimes, it may be advantageous to restrict this detection to a limited range of frequencies. For example, a user may wish to modify the generation of visual displays only if there are transients, or sudden changes in frequency, in higher frequencies. This user may want to ignore any transients in the lower frequencies of the audio data.

In one embodiment, a minimum frequency value and maximum frequency value are received from the user and these two frequencies are used to define a selected frequency range. The user may communicate the desired minimum and maximum frequency values through the user interface in an application using this embodiment by various means. For example, the user may type in the desired minimum and maximum frequency values or select them from a plurality of frequency values in pull-down menus in the application. Once a frequency range has been defined, all frequencies in the audio data outside this frequency range are ignored. One way of accomplishing this is by feeding the audio data through a bandpass filter to obtain filtered audio data because a bandpass filter with a passband delimited by the minimum frequency value and the maximum frequency value will “pass through” frequencies within the passband but will attenuate frequencies outside it. Transient detection may then be performed on the filtered audio data, not the original audio data, so that transients outside the frequency range of interest are ignored.

### Parameters of an Image Element

In one embodiment, the visual display generated displays at least one image element, where at least one parameter of the image element changes in response to detection of transients in audio data. An image element may be generated for visual display, and a parameter is any property of the image element. A simple example is where an image element is a square, and one of its parameters is size. Color and rotation are also parameters of a square image element.

In the simple example of the square where the size of the square generated becomes larger in correspondence to detection of transients, the square will pulse to a larger square whenever a transient is detected. This example has been illustrated in FIG. 2. Although not expressly illustrated, the color or rotation of the square may similarly change in response to transient detection.

A parameter of an image element can be more complex. For example, an image element may be an image of an apple, and one of its parameters may be gravity. In this example, the apple image element may by default “suspend in air”(i.e. be located in the upper half of the visual display), but its gravity parameter may be activated upon stimulus such as detection of a transient so as to cause the apple to “fall”(i.e. move to the bottom edge of the visual display at a rate of acceleration equal to the gravitational rate of acceleration or any other selected rate).

These two examples further illustrate that parameters can change both by varying in degree and by changing to a different state. In the first example, illustrated in FIG. 2, the degree to which the square is enlarged is related to the size of the transient. The bigger the transient (the bigger the change in frequency), the bigger the square. In the second example with gravity as a parameter, gravity was either “on” or “off”. By default, the gravity parameter of the apple image element is off, but upon the detection of a transient that meets a certain threshold value, the gravity will turn “on” and the apple will “fall”, regardless of how much the transient exceeds the threshold.

### Multiple Ranges and Multiple Parameters

An embodiment may also further provide the user with greater control over how a visual display is changed in response to transients in audio data.

As described above, the audio data can be filtered so that only transients in a frequency range of interest are detected. In another embodiment, several of these frequency ranges can be defined, allowing the user to specify which particular frequency ranges are of interest. An application using this embodiment may provide, through its user interface, means by which a user can specify more than one frequency range. For example, the user may type in commands to enter frequency ranges which will be accepted and recorded until the user types in a command that indicates that he or she has completed entering in the frequency ranges of interest.

For every frequency range defined, a different parameter may respond to transients in that frequency range differently. For example, two frequency ranges may be defined such that a low bass drum beat will result in transients in a first frequency range of lower frequencies while a cymbal clash will result in transients in a second frequency range of higher frequencies. In addition, a parameter of color for a square image element may change in response to transients in the first frequency range, while a parameter of rotation for the square may change in response to transients in the second frequency range. In this example, every time a low bass drum beat is played in the audio data, the square will change color. However, every time a cymbal is clashed in the audio data, the square will rotate. Additionally, if a low bass drum beat and a cymbal sound both occur at the same time, the square will both change color and rotate.

Parameters of different image elements may also respond to transients in different frequency ranges. For example, two different image elements, a square and a triangle, may be visually displayed at the same time. Furthermore, frequency ranges here may be defined as in the example above, and the color of the square may respond to transients in the first frequency range of lower frequencies while the rotation of the triangle may respond to transients in the second frequency range of higher frequencies. In this example, every time a low bass drum beat is played in the audio data, the square will change color. However, every time the cymbal is clashed in the audio data, the triangle will rotate. Finally, if a low bass drum beat and a cymbal sound both occur at the same time, the square will change color and the triangle will rotate at the same time.

### Multiple Time Segments

In another embodiment, the audio data can be divided into different time segments and the approaches described herein may be applied to each time segment. For example, a ten-minute song may be divided into two time segments consisting of the first five minutes of the song and the last five minutes of the song. For each of these time segments, a set of frequency ranges for transient detection and parameters may be applied, so that the visual display can change differently depending on which time segment it is in.

### Different Modes of Changing a Default Visual Display

As discussed above, detection of a transient at a point in time in audio data may result in modifying the default visual display to be generated at that point. This approach results in a sudden change in a series of generated visual displays at points where transients in the audio data are detected.

It may be advantageous to modify a series of generated visual displays in response to detection of transients in audio data such that the rate of visual change is not the “abrupt” change at a single point just described. In an embodiment, if a transient has been detected at a first sample point, a value used to generate the visual display associated with that sample point is modified in response to the detection, as discussed above. In addition, a value used to change the visual display associated with a sample point immediately before and a value used to change the visual display associated with a sample point immediately after the sample point may also be similarly modified. This results in a “square” visual change in the series of generated visual displays, where modified visual displays which are different from the default visual displays are sustained for a longer period of time. For example, a square visual display generated by default and a circle is generated at sample points where transients are detected. In this embodiment, a circle is also generated at sample points adjacent to sample points where transients are detected, resulting in several circles being generated in succession around a sample point where a transient is detected, thereby sustaining the display of a circle for a longer period of time.

In another embodiment, a visual change in a series of visual displays generated by default may be effected “smoothly”. Consider the example in FIG. 2, where the size of a square visual display generated depends on whether a transient was detected at a sample point. In addition, the size of the square visual displays generated at sample points before and after the sample point where a transient is detected may also similarly change, but in a magnitude corresponding to how close a sample point is to the sample point where a transient is detected. For example, if a transient is detected at sample point 5, resulting in generation of a square of size 10 at sample point 5 squares of size 9 can be generated at sample points 4 and 6, and squares of size 8 may be generated at sample points 3 and 7. This results in the square visual displays changing in size more smoothly, starting with sample point 4 and ending at sample point 7, instead of a big, abrupt, and isolated change in size of the square at sample point 5.

Finally, in another embodiment, a visual change in a series of visual displays generated by default may be effected “continuously”. In this embodiment, a default visual display is modified in a particular way at a sample point where a transient is detected. In addition, the generated visual displays at other sample points are modified such that the change from a visual image where there is no modification at all to a visual image where there is the highest amount of modification, which occurs at a sample point where a transient is detected, is continuous and smooth. For example, suppose that the default visual display to be generated is a square of size 1, and that the modified visual display to be generated if a transient is detect is a square of size 10. Furthermore, in a series of 20 sample points, a transient is detected at sample point 10. In this example, a square of size 1 is generated for sample points 1 and 10, and a square of size 10 is generated at sample point 10. For sample points 2 through 9, however, squares between sizes 1 and 10 and increasing getting bigger are generated. Similarly, for sample points 11 through 20, square between sizes 10 and 1 and increasing getting smaller are generated. This results in the square visual displays changing in size continuously from a small square to a large square and back to a small square, instead of a big, abrupt, and isolated change in size of the square at sample point 10.

### Generating a Second Audio Data Based on a First Audio Data

The approaches described herein for generating a series of visual displays may similarly be applied to modify audio data. In one embodiment, a first audio data is received and processed as described herein to perform transient detection. Detection of a transient at a sample point results in the modification of a value associated with that sample point. A second audio data may be received and processed such that a parameter of the second audio data, such as the volume or balance, may be modified based on whether the value associated with that sample point has been modified in response to detection of a transient affects the audio frame generated.

### Hardware Overview

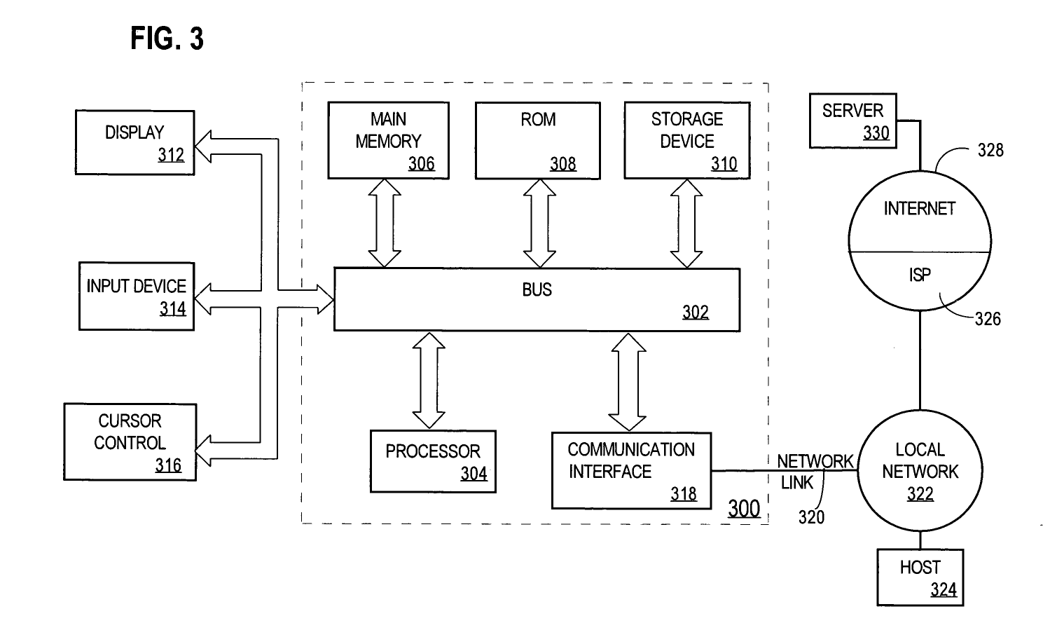

FIG. 3 is a block diagram that illustrates a computer system 300 upon which an embodiment of the invention may be implemented. Computer system 300 includes a bus 302 or other communication mechanism for communicating information, and a processor 304 coupled with bus 302 for processing information. Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Computer system 300 further includes a read only memory (ROM) 308 or other static storage device coupled to bus 302 for storing static information and instructions for processor 304. A storage device 310, such as a magnetic disk or optical disk, is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

The invention is related to the use of computer system 300 for implementing the techniques described herein. According to one embodiment of the invention, those techniques are performed by computer system 300 in response to processor 304 executing one or more sequences of one or more instructions contained in main memory 306. Such instructions may be read into main memory 306 from another machine-readable medium, such as storage device 310. Execution of the sequences of instructions contained in main memory 306 causes processor 304 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 300, various machine-readable media are involved, for example, in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 304 for execution. For example, the instructions may initially be carried on a magnetic disk of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are exemplary forms of carrier waves transporting the information.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution. In this manner, computer system 300 may obtain application code in the form of a carrier wave.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for generating visual displays based on audio data, the method comprising:
receiving audio data having a plurality of frequencies;
sampling the audio data at a series of sample points;
at each sample point,
detecting a transient;
in response to detecting a transient at the sample point, modifying at least one value associated with the sample point;
generating a series of visual displays corresponding to the series of sample points,
which comprises:
at each sample point, generating a visual display based at least in part on the at least one value associated with the sample point.

2. The method of claim 1, wherein the series of sample points is a series of points in time separated by an amount of time determined by a sampling rate.

3. The method of claim 2, wherein the sampling rate is received as user input in response to user manipulation of an input device.

4. The method of claim 1, wherein:
the visual display associated with the sample point contains at least one image element;
the image element has at least one parameter; and
the step of modifying at least one value associated with the sample point comprises modifying the at least one parameter.

5. The method of claim 1, wherein:
the visual display contains at least one image element;
the at least one value indicates whether the at least one image element is replaced by a substitute image element.

6. The method of claim 1, wherein the step of generating a series of visual displays corresponding to the series of sample points comprises:
at each sample point, generating a visual display based at least in part on the at least one value associated with the sample point and the values associated with other sample points in the series of sample points.

7. A method for generating visual display based on audio data, the method comprising:
receiving audio data having a plurality of frequencies;
receiving a minimum frequency value and a maximum frequency value;
processing the audio data to achieve a filtered audio data, wherein the filtered audio data comprises the audio data without any frequencies lower than the minimum frequency value or higher than the maximum frequency value;
sampling the filtered audio data at a series of sample points;
at each sample point,
detecting a transient;
in response to detecting a transient at the sample point, modifying at least one value associated with the sample point;
wherein the at least one value is used to generate the visual display associated with the sample point; and
generating a series of visual displays corresponding to the series of sample points,
which comprises:
at each sample point, generating a visual display based at least in part on the at least one value associated with the sample point.

8. The method of claim 7, wherein the step of processing audio data to achieve a filtered audio data comprises filtering the audio data through a bandpass filter having a passband delimited by a lower frequency and a higher frequency, wherein the lower frequency is the minimum frequency value and the higher frequency is the maximum frequency value.

9. The method of claim 7, wherein the minimum frequency value and the maximum frequency value are received as user input in response to user manipulation of an input device.

10. A method for generating a visual display based on audio data, the method comprising:
detecting a transient;
determining which frequency range, of a plurality of possible frequency ranges, into which the transient falls;
if the transient falls within a first frequency range, then modifying at least one first value
wherein the at least one first value effects a first change to the generating of the visual display;
if the transient falls within a second frequency range that is different from the first frequency range, then modifying at least one second value
wherein the at least one second value effects a second change to the generating of the visual display
wherein the second change is visually different from the first change.

11. An apparatus for generating visual display based on audio data, the device comprising:
one or more processors;
a display screen coupled to the one or more processors; and
a memory coupled to the one or more processors, the memory having stored therein instructions, wherein execution of the instructions by the one or more processors causes the one or more processors to perform a method, the method comprising:
receiving audio data having a plurality of frequencies;
sampling the audio data at a series of sample points;
at each sample point,
detecting a transient;
in response to detecting a transient at the sample point,
modifying at least one value associated with the sample point;
wherein the at least one value is used to generate the visual display associated with the sample point.
generating a series of visual displays corresponding to the series of sample points, which comprises:
at each sample point, generating a visual display based at least in part on the at least one value associated with the sample point.

12. The apparatus of claim 11, wherein the series of sample points is a series of points in time separated by an amount of time determined by a sampling rate.

13. The apparatus of claim 11, wherein the sampling rate is received as user input in response to user manipulation of an input device.

14. The apparatus of claim 11, wherein:
the visual display contains at least one image element;
the image element has least one parameter; and
the instruction for modifying at least one value associated with the sample point comprises modifying the at least one parameter.

15. The apparatus of claim 11, wherein:
the visual display contains at least one image element;
the at least one value indicates whether the at least one image element is replaced by a substitute image element.

16. The apparatus of claim 11, wherein the instruction for generating a series of visual displays corresponding to the series of sample points comprises:
at each sample point, generating a visual display based at least in part on the at least one value associated with the sample point and the values associated with other sample points in the series of sample points.

17. An apparatus for changing a visual display during playback of audio data, the device comprising:
one or more processors;
a display screen coupled to the one or more processors; and
a memory coupled to the one or more processors, the memory having stored therein instructions, wherein execution of the instructions by the one or more processors causes the one or more processors to perform a method, the method comprising:
receiving audio data having a plurality of frequencies;
receiving a minimum frequency value and a maximum frequency value;
processing the audio data to achieve a filtered audio data, wherein the filtered audio data comprises the audio data, without any frequencies lower than the minimum frequency value or higher than the maximum frequency value;
sampling the filtered audio data at a series of sample points;
at each sample point,
detecting a transient;
in response to detecting a transient at the sample point,
modifying at least one value associated with the sample point;
wherein the at least one value is used to generate the visual display associated with the sample point; and
generating a series of visual displays corresponding to the series of sample points, which comprises:
at each sample point, generating a visual display based at least in part on the at least one value associated with the sample point.

18. The apparatus of claim 17, wherein the instruction for processing the audio data to achieve a filtered audio data comprises filtering the audio data through a bandpass filter having a passband delimited by a lower frequency and a higher frequency, wherein the lower frequency is the minimum frequency value and the higher frequency is the maximum frequency value.

19. The apparatus of claim 17, wherein the instruction for receiving a minimum frequency value and a maximum frequency value further comprises receiving the minimum frequency value and the maximum frequency value as user input in response to user manipulation of an input device.

20. A machine-readable medium carrying instructions for changing a visual display, wherein execution of the instructions by one or more processors performs a method, said method comprising:
receiving audio data having a plurality of frequencies;
sampling the audio data at a series of sample points;
at each sample point,
detecting a transient;
in response to detecting a transient at the sample point, modifying at least one value associated with the sample point;
wherein the at least one value is used to generate the visual display associated with the sample point; and
generating a series of visual displays corresponding to the series of sample points,
which comprises:
at each sample point, generating a visual display based at least in part on the at least one value associated with the sample point.

21. The apparatus of claim 20, wherein the series of sample points is a series of points in time separated by an amount of time determined by a sampling rate.

22. The apparatus of claim 20, wherein the sampling rate is received as user input in response to user manipulation of an input device.

23. The apparatus of claim 20, wherein:
the visual display contains at least one image element;
the image element has least one parameter; and
the instruction for modifying at least one value associated with the sample point comprises modifying the at least one parameter.

24. The apparatus of claim 20, wherein:
the visual display contains at least one image element;
the at least one value indicates whether the at least one image element is replaced by a substitute image element.

25. The apparatus of claim 20, wherein the instruction for generating a series of visual displays corresponding to the series of sample points comprises:
at each sample point, generating a visual display based at least in part on the at least one value associated with the sample point and the values associated with other sample points in the series of sample points.

26. A machine-readable medium carrying instructions for changing a visual display, wherein execution of the instructions by one or more processors performs a method, said method comprising:
receiving audio data having a plurality of frequencies;
receiving a minimum frequency value and a maximum frequency value;
processing the audio data to achieve a filtered audio data, wherein the filtered audio data comprises the audio data without any frequencies lower than the minimum frequency value or higher than the maximum frequency value;
sampling the filtered audio data at a series of sample points;
at each sample point,
detecting a transient;
in response to detecting a transient at the sample point, modifying at least one value associated with the sample point;
wherein the at least one value is used to generate the visual display associated with the sample point; and
generating a series of visual displays corresponding to the series of sample points,
which comprises:
at each sample point, generating a visual display based at least in part on the at least one value associated with the sample point.

27. The apparatus of claim 26, wherein the instruction for processing the audio data to achieve a filtered audio data comprises filtering the audio data through a bandpass filter having a passband delimited by a lower frequency and a higher frequency, wherein the lower frequency is the minimum frequency value and the higher frequency is the maximum frequency value.

28. The apparatus of claim 26, wherein the instruction for receiving a minimum frequency value and a maximum frequency value further comprises receiving the minimum frequency value and the maximum frequency value as user input in response to user manipulation of an input device.

29. A method for modifying a second audio data based on a first audio data, the method comprising:
receiving a first audio data having a plurality of frequencies;
sampling the first audio data at a series of sample points;
at each sample point,
detecting a transient;
in response to detecting a transient at the sample point, modifying at least one value associated with the sample point;
receiving a second audio data having at least one parameter at each sample point in the series of sample points;
modifying the second audio data at the series of sample points, which comprises:
at each sample point, modifying at least one parameter of the second audio data at the sample point based at least in part on the at least one value associated with the sample point.
